(19) United States
(12) Patent Application Publication
(10) Pub. No.: US 2008/0226124 A1
(43) Pub. Date: Sep. 18, 2008

(54) Method For Inserting and Extracting Multi-Bit Fingerprint Based on Wavelet

(76) Inventors: Yong Seok Seo, Daejon (KR); Hye Won Jung, Daejon (KR); Won Gyum Kim, Daejon (KR); Seon Hwa Lee, Daejon (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/066,421

(22) PCT Filed: Dec. 14, 2005
(86) PCT No.: PCT/KR2005/004287

§ 371 Date: Mar. 11, 2008

(30) Foreign Application Priority Data
Nov. 15, 2005 (KR) 10-2005-0109002

(51) Int. Cl. G06K 9/00

(52) U.S. Cl. 382/100

(57) ABSTRACT

A method for inserting and extracting a fingerprint based on a wavelet is disclosed. The method includes: a) decomposing an original image into a first sub-band image having low frequency band columns and rows, a second sub-band image having high frequency band columns and low frequency band rows, a third sub-band image having low frequency band columns and high frequency band rows and a fourth sub-band image having high frequency band columns and rows by performing an n-level discrete wavelet transformation on an original image; b) obtaining a human visual system model from the first sub-band image; c) generating an N×N fingerprint basic block by performing a message modulation on a multi-bit fingerprint signal with a security key and adding a synch pattern to the modulated signal; d) repeatedly inserting the fingerprint basic block in to the second, the third and the fourth sub-band images with reference to the human visual system model; and e) generating a fingerprint inserted image by performing an inverse discrete wavelet transformation on the first sub-band image and the fingerprint basic block inserted second, third and fourth sub-band images.

### TECHNICAL FIELD

The present invention relates to a method for inserting and extracting a multi-bit fingerprint based on a wavelet transformation, and more particularly to a method for extracting a multi-bit fingerprint after recovering an image having a geometrical transformation such as a rotation, scaling or translation by generating a square fingerprint block through reconfiguring a multi-bit fingerprint signal with a synchronization signal and repeatedly inserting the square fingerprint block into wavelet-transformed areas with using the synchronization signal.

### BACKGROUND ART

As a method of protecting a copyright of multimedia contents in the Internet environment, a watermarking or a fingerprinting scheme were introduced. These schemes prove the ownership of the contents by inserting a predetermined signal into the content itself. The watermarking scheme inserts owner's information into the contents, and the fingerprint scheme inserts purchaser's information into the contents when the purchaser buys the contents. Using the fingerprint, a purchaser who illegally distributes the contents can be traced.

It is very important to design a fingerprint to resist illegal attack to eliminate the fingerprint from the contents as well as invisibly inserting the fingerprint into the contents. The illegal attack may be classified into a non-geometrical transformation such as compression or filtering and a geometrical transformation such as rotation, scaling and translation.

A conventional fingerprinting scheme based on repeatedly inserting a fingerprint is known as an effective method to protect the copyright from the geometrical transformation. According to the conventional fingerprinting scheme, it is possible to predict a geometrical formation of an image and to recover an original image based on the predicted geometrical formation by obtaining a periodic auto-correlation pattern when a fingerprint is extracted. However, such an auto-correlation peak can be eliminated by the illegal attacks such as the geometric transformation or the image processing. Therefore, there is greater demand to precisely predict a level of geometrical transformation based on extracted peak candidates.

### Disclosure of Invention

### Technical Problem

An object of the present invention is to provide a method for extracting a multi-bit fingerprint after recovering an image having a geometrical transformation such as a rotation, scaling or translation by generating a square fingerprint block through re-configuring a multi-bit fingerprint signal with a synchronization signal and repeatedly inserting the square fingerprint block into wavelet-transformed areas with using the synchronization signal in order to effectively protect a copyright of contents from a geometrical attack.

### Technical Solution

To achieve these and other advantages and in accordance with the purpose of the present invention, as embodied and broadly described, there is provided a method of inserting a multi-bit fingerprint based on a wavelet including the steps of: a) decomposing an original image into a first sub-band image having low frequency band columns and rows, a second sub-band image having high frequency band columns and low frequency band rows, a third sub-band image having low frequency band columns and high frequency band rows and a fourth sub-band image having high frequency band columns and rows by performing an n-level discrete wavelet transformation on an original image; b) obtaining a human visual system model from the first sub-band image; c) generating an N×N fingerprint basic block by performing a message modulation on a multi-bit fingerprint signal with a security key and adding a synch pattern to the modulated signal; d) repeatedly inserting the fingerprint basic block in to the second, the third and the fourth sub-band images with reference to the human visual system model; and e) generating a fingerprint inserted image by performing an inverse discrete wavelet transformation on the first sub-band image and the fingerprint basic block inserted second, third and fourth sub-band images.

In accordance with another aspect of the present invention, there is provided a method of extracting a multi-bit fingerprint based on a wavelet including the steps of: a) estimating original signal having a fingerprint from a fingerprint inserted image; b) detecting a peak from a self-reference pattern obtained from an auto-correlation of the estimated original signal; c) extracting rotation and scaling information from the detected peak and correcting a rotation transformation and a scaling transformation of the original signal having the fingerprint based on the extracted rotation and scaling information; d) obtaining an estimated fingerprint part signal from the corrected original signal, extracting translation information from a cross correlation peak between the estimated fingerprint part signal and a synchronization signal, and correcting a translation transformation of the original signal having the fingerprint; and e) extracting a fingerprint from the rotation, scaling and translation corrected original signal using a sub-band merge signal.

### Advantageous Effects

A method of inserting and extracting a multi-bit fingerprint according to the present invention decomposes an original image into sub-band images through a wavelet transformation, repeatedly inserts the fingerprint the decomposed sub-band images, and corrects rotation, scaling and translation formations. Therefore, the method of inserting and extracting a multi-bit fingerprint according to the present invention can be used to firmly protect multimedia contents from both of the geometrical attacks and the lossey compression such as JPEG. Furthermore, the method of inserting and extracting a multi-bit fingerprint according to the present invention also can be used to firmly protect an image having different messages inserted form a collusion attack such as an averaging attack or a mosaic attack.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a view for showing a method of inserting a multi-bit fingerprint according to an embodiment of the present invention;

FIG. 2 schematically shows a method of extracting a multi-bit fingerprint according to an embodiment of the present invention;

FIG. 3 shows a generation of a multi-bit fingerprint signal in the method of inserting the multi-bit fingerprint shown in FIG. 1;

FIG. 4 shows a generation of a fingerprint block in the method of inserting a multi-bit fingerprint in the method of inserting the multi-bit fingerprint shown in FIG. 1;

FIG. 5 shows an insertion of a fingerprint block into wavelet sub-band areas of the original image in the method of inserting the multi-bit fingerprint shown in FIG. 1;

FIG. 6 shows a generation of a synch part signal used for correcting a translation of an original image in the method of extracting the multi-bit fingerprint shown in FIG. 2;

FIG. 7 shows a generation of an estimated fingerprint part signal used to correct the translation of the image in the method of extracting the multi-bit fingerprint shown in FIG. 2; and

FIG. 8 shows a correction of translation transformation and an extraction of the fingerprint information in a method of extracting a multi-bit fingerprint in the method of extracting the multi-bit fingerprint shown in FIG. 2.

### BEST MODE FOR CARRYING OUT THE INVENTION

Reference will now be made in detail to the preferred embodiments of the present invention, examples of which are illustrated in the accompanying drawings.

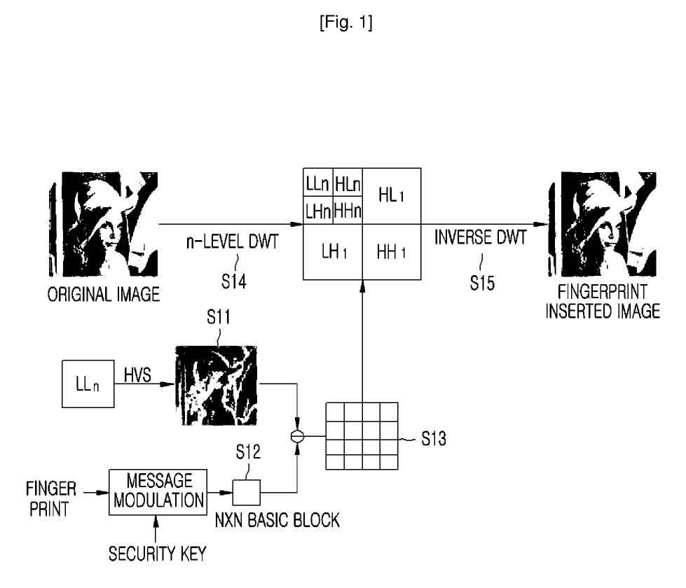

FIG. 1 is a view for showing a method of inserting a multi-bit fingerprint according to an embodiment of the present invention.

The method of inserting a multi-bit fingerprint according to the present embodiment uses a wavelet transformation and an inverse wavelet transformation. The wavelet transformation may be called as a wavelet decomposition. The wavelet transformation is a method of coding an image through dividing the image by a frequency bandwidth of the image using a low-pass filter and a high-pass filter. The wavelet transformation is generally used to process images for compressing. In the present invention, an original image is divided into a plurality of sub-band images by performing a discreet wavelet transformation (DWT) on the original image and a multi-bit fingerprint created according to the present invention is inserted into the divided sub-band images. After inserting the multi-bit fingerprint, an inverse DWT is performed on the divided sub-band images to generate a fingerprint inserted image.

While performing the DWT on the original image, the original image is decomposed using a low-pass filter for columns of the original image and a high-pass filter for rows of the original image because the image is generally two-dimensional signal. As a result, the original image is decomposed into four sub-band images LL₁, LH₁, HL₁ and HH_{1.} The sub-band image LL₁ is composed of low frequency band columns and rows, the sub-band image LH₁ is composed of low frequency band columns and high frequency band rows, the sub-band image HL₁ is composed of high frequency band columns and low frequency band rows, and the sub-band image HH₁ is composed of high frequency band columns and rows. Since the sub-band image LL1 has almost all of information about the original image, the sub-band image LL1 is treated as a new image and the DWT may be performed on the sub-band image LL1 again. Herein, an n-level discrete wavelet transformation denotes that the DWT is performed on an image n times based on the above described method.

Hereinafter, a method of inserting a multi-bit fingerprint according to the present invention will be described with reference to FIGS. 1 and 3 through 5.

At first, sub-band images LLₙ are obtained by performing an n-level DWT on an original image. Then, a human visual system (HVS) model is obtained from the sub-band images LLₙ at step S11. After obtaining the HVS model, an N×N fingerprint basic block is obtained at step S12 by modulating a multi-bit fingerprint signal with a security key and inserting a sync pattern into the modulated signal, where the sync pattern is a synchronization signal.

Meanwhile, the n-level DWT is performed on the original image at step S14 to obtain sub-band images shown in FIG. 1. the N×N fingerprint basic block generated at the step S12 is repeatedly inserted into the sub-band images HLₙ, LHₙ and HHₙ at the step S13 with reference to the HVS model obtained in the step S11. Then, the fingerprint inserted image is obtained by performing the inverse DWT on the sub-band image LLₙ and the N×N fingerprint basic block inserted sub-band images HLₙ, LHₙ and HHₙ at step S15.

In the present embodiment, a 2-level DWT is performed. However, the present invention is not limited thereby. That is, if an n-level DWT may be performed, a HVS model may be obtained from the sub-band images LLₙ at step S11 and the fingerprint basic block is repeatedly inserted into the sub-images HLₙ, LHₙ and HHₙ.

In the present embodiment, the size of original image is 512×512, and the size of fingerprint basic block is 32×32. The fingerprint basic block is inserted to each sub-band image HL₂, LH₂ or HH₂ more than 16 times. The reason of repeatedly inserting is for using the fingerprint inserted image as a template to correct a transformed image by rotating or scaling among the geometrical attacks. If the fingerprint block is inserted repeatedly in a unit of block size, a constant auto-correlation can be obtained when the fingerprint is extracted from the image. It is called as a self reference pattern. It is used as the template to calculate inverse information about geometric transformation and the image is corrected according to the calculated inverse information.

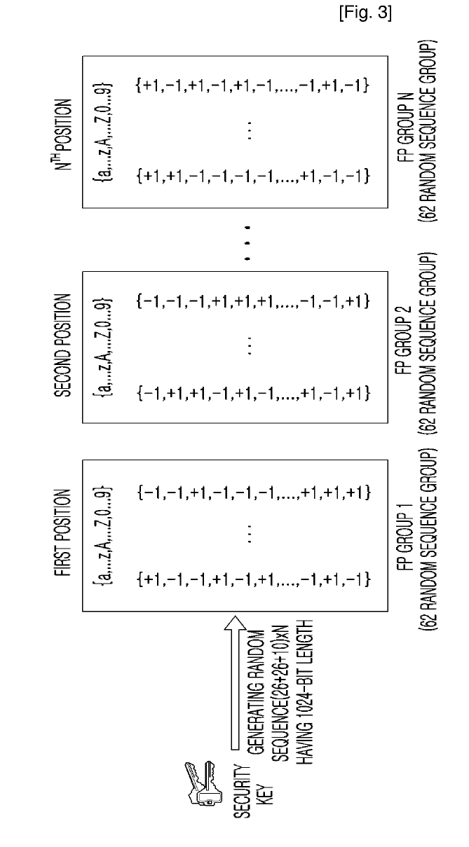

FIG. 3 shows a generation of a multi-bit fingerprint signal in the step S12 in the method of inserting the multi-bit fingerprint shown in FIG. 1.

In FIG. 3, a step for generating N fingerprint group FP 1 to FPN as long as a length of a message from 62 random signals each of which having a 1024-bit length per each message. Each message is one of 62 signals representing 52 uppercase and lowercase alphabets and 10 numbers. Such 62 alphabets and numbers are expressed as a 1024-bit random signal by a security key. In the present embodiment, a 64-bit of fingerprint is inserted in order to insert a message of eight ciphers.

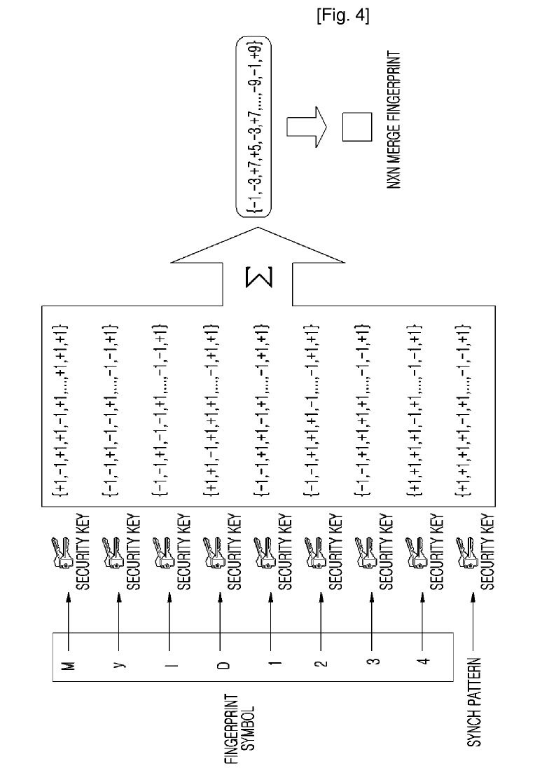

FIG. 4 shows a generation of a fingerprint block in the method of inserting a multi-bit fingerprint according to an embodiment of the present invention. That is, FIG. 4 shows transforming of the multi-bit fingerprint signal, that is, the message of eight ciphers, to a 32×32 basic block configured of −1 s and +1 s.

In FIG. 4, each message of 8 figures is a 1024 bit random signal configured of −1 s and +1 s, which is generated by a security key. A 1024-bit merge fingerprint signal configured of number in a range of −9 to +9 is generated by merging the 1024-bit random signal with a sync pattern that is another random signal. In order to insert the generated merge fingerprint signal into the image, the merge fingerprint signal is transformed to a new signal configured of −1 and +1. For example, numbers in the merge fingerprint signal, which are smaller than 0, is transformed to −1, and numbers in the merge fingerprint signal, which are larger than 0, is transformed to +1. Then, the one-dimensional 1024 merge fingerprint signal is rearranged to a two-dimensional 32×32 fingerprint block.

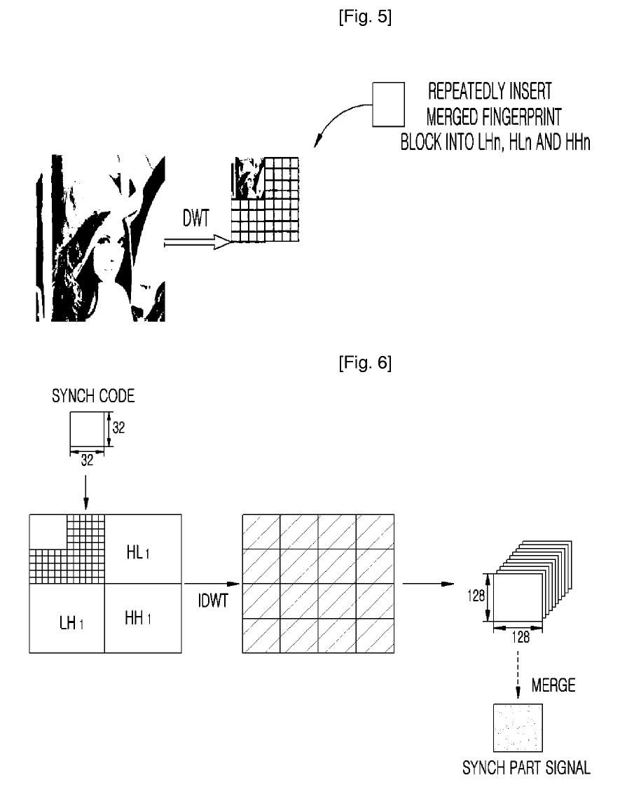

FIG. 5 shows an insertion of a fingerprint block into wavelet sub-band areas of the original image according to an embodiment of the present invention. As shown, the 32×32 fingerprint block generated in FIG. 4 is repeatedly inserted in to each of the sub-band images HL₂, LH₂ and HH₂ after performing a two-level DWT on the original image as shown in FIG. 5.

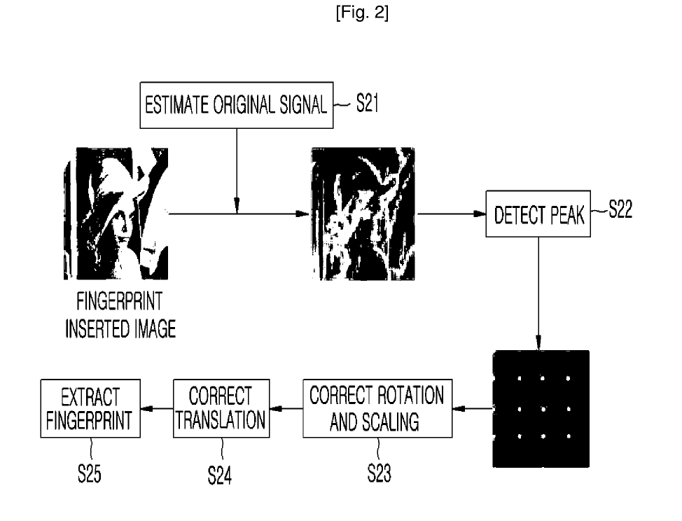

Hereinafter, a method of extracting a multi-bit fingerprint according to the present invention will be described with reference to FIGS. 2 and 6 to 8.

FIG. 2 schematically shows a method of extracting a multi-bit fingerprint according to an embodiment of the present invention. As shown in FIG. 2, the method of extracting a multi-bit fingerprint includes: estimating original signal having a fingerprint from a fingerprint inserted image at step S21; obtaining a peak from a self-reference pattern obtained by an auto-correlation of the estimated original signal at step S22; extracting rotation and scaling information from the detected peak and correcting the original signal having the fingerprint based on the extracted rotation and scaling information at step S23; obtaining an estimated fingerprint signal from the corrected original signal, extracting translation information from a cross correlation peak between the estimated fingerprint signal and the sync pattern signal, and correcting the translation of the original signal having the fingerprint at step S24; and extracting a fingerprint from the rotation, scaling and translation corrected original signal at step S25.

In the step S21 for estimating the original signal having the fingerprint, a noise component having a fingerprint is extracted from a fingerprint inserted image. Generally, a wiener filter or a high-pass filter is used. In the present embodiment, the wiener filter is used.

In the step S22 for detecting the peak, the auto-correlation of the estimated original signal having the fingerprint. As a result, the peak repeatedly shown in the self-reference pattern generated by the auto-correlation is detected.

In the step S23, the rotation and scaling information is extracted from the peak information detected at the step S22. In the present invention, information about a straight line formed of the extracted peaks is extracted and the rotation and scaling information is extracted from information about a slope of the straight line and distances between points forming the straight line.

FIG. 6 shows a generation of a synch part signal used for correcting a translation of an original image according to the present invention.

While inserting the fingerprint as described with reference to FIG. 4, the 1024-bit synch pattern signal generated by the security key is rearranged in a two dimensional formation and accordingly, a two dimensional 32×32 fingerprint block is generated. The synch pattern signal is repeatedly inserted to sub-band images HLₙ, LHₙ and HHₙ obtained by performing the DWT on an image having all pixels of zero. Then, the synch pat signal is generated by performing the inverse DWT on these sub-band images.

Referring to FIG. 6, the fingerprint block inserted image is decomposed into 128×128 blocks, and the divided 128×128 blocks are merged to generate the sync part signal. The sync part signal is used to correct the translation of the image when extracting the fingerprint. In the present embodiment, the size of the image having all pixels of 0 is a size of 512×512 which is identical to the size of the original image.

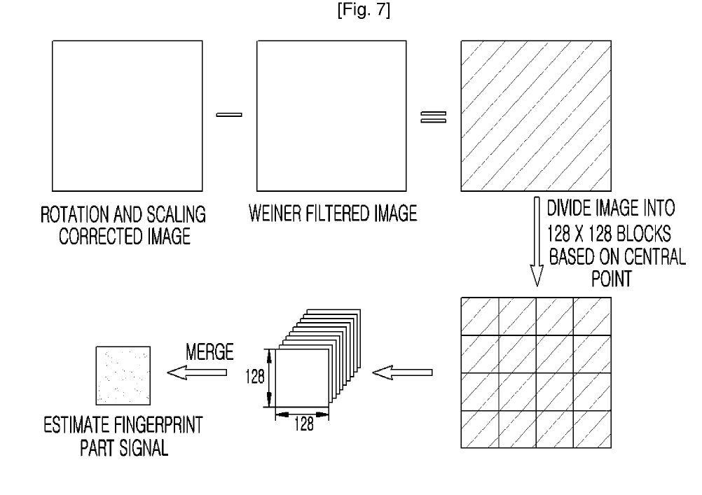

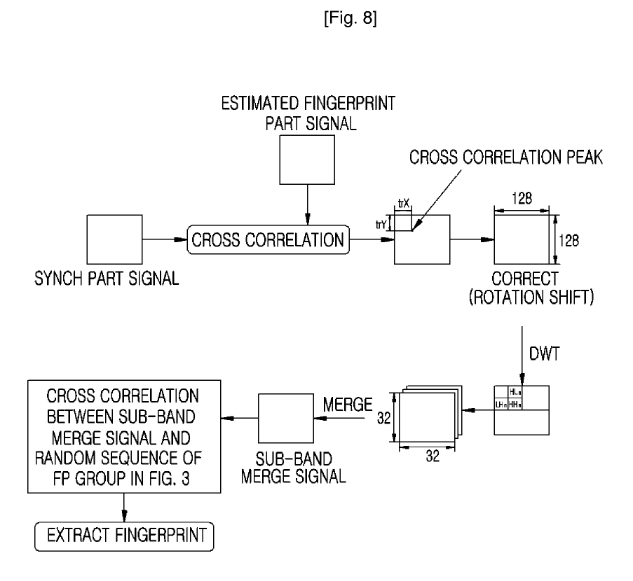

FIG. 7 shows a generation of an estimated fingerprint part signal used to correct the translation of the image according to an embodiment of the present invention. In particular, FIG. 7 shows the generation of the estimated fingerprinting part signal for correcting the translation using the rotating and scaling corrected image.

At first, an original signal is estimated from the rotating and scaling corrected image. The original signal can be easily obtained from a difference between the rotating and scaling corrected image and an image filtered by the wiener filter. The estimated fingerprinting part signal is generated by adding the estimated original signal with the 128×128 divided images. The estimated fingerprinting part signal is used to correct the translation transformation with the synch part signal while extracting the fingerprint.

FIG. 8 shows a correction of translation transformation and an extraction of the fingerprint information in a method of extracting a multi-bit fingerprint according to an embodiment of the present invention.

In order to correct the translation formation of image, the cross correlation is obtained between the synch part signal and the estimated fingerprinting part signal. From the obtained cross correlation, a location of cross correlation peak between the synch part signal and the estimated fingerprinting part signal is obtained. The level of translation formation is detected based on the obtained location of the cross correlation peak. A circular shift is performed using the location peak as an origin (0.0) to merge sub-band images. As a result, a sub-band merging signal M₁₃ part is generated. Then, the fingerprint, 64-bit of eight text messages, is extracted from the original image by obtaining a cross correlation between the sub-band merging signal M_part and random sequences of fingerprint group (FP) shown in FIG. 3.

Although the preferred embodiments of the present invention have been disclosed for illustrative purpose, those skilled in the art will appreciate that various modifications, additions and substitutions can be made without departing from the scope and spirit of the invention as defined in the accompanying claims.

1. A method of inserting a multi-bit fingerprint based on a wavelet comprising the steps of:
a) decomposing an original image into a first sub-band image having low frequency band columns and rows, a second sub-band image having high frequency band columns and low frequency band rows, a third sub-band image having low frequency band columns and high frequency band rows and a fourth sub-band image having high frequency band columns and rows by performing an n-level discrete wavelet transformation on an original image;
b) obtaining a human visual system model from the first sub-band image;
c) generating an N×N fingerprint basic block by performing a message modulation on a multi-bit fingerprint signal with a security key and adding a synch pattern to the modulated signal;
d) repeatedly inserting the fingerprint basic block in to the second, the third and the fourth sub-band images with reference to the human visual system model;
and
e) generating a fingerprint inserted image by performing an inverse discrete wavelet transformation on the first sub-band image and the fingerprint basic block inserted second, third and fourth sub-band images.

2. The method of claim 1, wherein in the step C), the multi-bit fingerprint signal is modulated with the security key by selecting a message having predetermined alphabets and numbers and transforming the selected message with the security to a random signal.

3. The method of claim 2, wherein the fingerprint basic block in the step c) is generated to have a predetermined size by obtaining a merged fingerprint signal through adding a synch pattern to the generated random signal and rearranging the merged fingerprint signal in two dimensional formation.

4. A method of extracting a multi-bit fingerprint based on a wavelet comprising the steps of:
a) estimating original signal having a fingerprint from a fingerprint inserted image;
b) detecting a peak from a self-reference pattern obtained from an auto-correlation of the estimated original signal;
c) extracting rotation and scaling information from the detected peak and correcting a rotation transformation and a scaling transformation of the original signal having the fingerprint based on the extracted rotation and scaling information;
d) obtaining an estimated fingerprint part signal from the corrected original signal, extracting translation information from a cross correlation peak between the estimated fingerprint part signal and a synchronization signal, and correcting a translation transformation of the original signal having the fingerprint; and
e) extracting a fingerprint from the rotation, scaling and translation corrected original signal using a sub-band merge signal.

5. The method of claim 4, wherein in the step c), information about a straight line formed of the extracted peaks at the step b) is obtained and the rotation and scaling information is extracted based on a slope of the straight line and a distance between points forming the straight line.

6. The method of claim 4, wherein the synchronization signal in the step d) is a signal inserted into a fingerprint basic block while inserting a fingerprint and is generated by dividing a fingerprint block inserted image into divided images each having a predetermined size and merging the divided images.

7. The method of claim 4, wherein the estimated finger print part signal of the step d) is generated by dividing the estimated original signal into divided images having a predetermined size based on a center point and adding the divided images.

8. The method of claim 4, wherein in the step c), the sub-band merge signal is obtained by merging sub-band images obtained through performing a discrete wavelet transformation on a rotation, scaling, and the fingerprint is extracted from the image by a cross correlation between the sub-band merge signal and a random signal of a fingerprint group.
